(19) United States
(12) Patent Application Publication
(10) Pub. No.: US 2017/0015221 A1
(43) Pub. Date: Jan. 19, 2017

(54) VEHICLE SEAT HAVING A SELF-LOCKING-FREE DRIVE DEVICE FOR ADJUSTING THE BACKREST THEROF

(71) Applicant: Brose Fahrzeugteile GmbH & Co. Kommanditgesellscha ft, Coburg, Coburg (DE)

(72) Inventors: Martin SPANGLER, Laaber (DE); Jochen HOFMANN, Marktgraitz (DE); Sandra KIESER, Coburg (DE); Georg KRÖNER, Bischberg (DE)

(21) Appl. No.: 15/209,620

(22) Filed: Jul. 13, 2016

(30) Foreign Application Priority Data
Jul. 14, 2015 (DE) 10 2015 213 188.2

(51) Int. Cl. B60N 2/225; B60N 2/23; B60N 2/22; B60N 2/02; B60N 2/20

(52) U.S. Cl. CPC B60N 2/2254; B60N 2/0232; B60N 2/20; B60N 2/2227; B60N 2/0244; B60N 2/23; B60N 2002/0272; B60N 2002/0236

(57) ABSTRACT

A vehicle seat is provided having at least one lower seat member which defines a seat face for a seat occupant and a backrest which, on the one hand, can be adjusted in terms of the inclination thereof relative to the lower seat member in a position for use or comfort position, in which the back of a seat occupant can be supported by means of the backrest in accordance with provisions and which, on the other hand, can be pivoted out of the position for use in the direction toward the lower seat member into a non-use position, for example, a so-called cargo position, in which a person can sit on the vehicle seat not in accordance with provisions. There is provided on the vehicle seat a self-locking-free drive device.

### CROSS-REFERENCE TO RELATED APPLICATION

This application claims priority to German Patent Application No. 10 2015 213 188.2 filed on Jul. 14, 2015, the entirety of which is incorporated by reference herein.

### BACKGROUND

The present invention relates in particular to a vehicle seat.

A vehicle seat of the generic type has at least one lower seat member and a backrest which can be pivoted relative thereto about a backrest pivot axis. The lower seat member defines a seat face for a seat occupant of the vehicle seat. The backrest is, on the one hand, adjustable in terms of the inclination thereof relative to the lower seat member in a position for use, in which the back of a seat occupant is supported by means of the backrest in accordance with provisions. Generally, a fitting arrangement is provided for this purpose so as to have a rotational or catch fitting. On the other hand, the backrest can be pivoted out of the position for use thereof in the direction toward the lower seat member into a non-use position, in which a person can sit on the vehicle seat not/no longer in accordance with provisions so that his/her back would be supported by means of the backrest. The non-use position is, for example, a cargo, table-like or easy-entry position. The non-use position is consequently used conventionally to increase a loading or useful area inside a vehicle or to make access easier to a (sitting or loading) region located behind the vehicle seat.

In the case of vehicle seats previously used in practice for a second or third seat row, they are often only able to be pivoted or folded between a position for use and a non-use position. It is not possible to adjust the inclination of the backrest in the position for use thereof. In order to increase comfort, however, it is further also currently conventional particularly in top-of the-range vehicles to provide an external-force-actuated adjustment of the backrest of a vehicle seat of the second or third seat row from a position for use into the forward-folded non-use position. It is also currently conventional to be able to adjust the backrest in terms of the inclination thereof relative to a lower seat member with actuation by an external force in driver seats and front-passenger seats of a motor vehicle, for example, by means of an electric motor.

In previously known and conventional adjustment mechanisms for a vehicle seat having a backrest which can both be adjusted in terms of the inclination thereof, and therefore in different comfort positions, and be folded or pivoted forward onto a lower seat member into a non-use position, it is always weighed up which of the adjustment movements of the backrest are intended to be brought about manually or with actuation by an external force. In this instance, there are provided different adjustment concepts for the inclination adjustment in the position for use and the adjustment from the position for use into the non-use position and/or resetting into the position for use. For example, the inclination adjustment is carried out with actuation by an external force by means of a first drive device having a first drive motor, while the folding of the backrest forward into a non-use position is carried out manually, and a second drive device having a second drive motor is provided for folding the backrest backward.

Thus, for example, U.S. Pat. No. 6,131,999 also discloses a vehicle seat in which an adjustment of the backrest between the position for use and the non-use position is carried out via an independent drive device having a push rod drive. An inclination adjustment of the backrest in the position for use thereof is carried out via a separate rotational or catch fitting which is decoupled from the push rod drive.

In vehicle seats which are known from the prior art, the adjustment mechanisms and associated drive devices for the adjustment of a backrest must consequently always be configured in a complex manner in order to provide either a manual adjustment or an external-force-actuated adjustment of the backrest for one purpose or the other. Furthermore, the weight of the vehicle seat is sometimes substantially increased as a result of the generally complex and expensive drive devices for the external-force-actuated adjustment which generally have an electromotive drive therefor. This is very difficult to combine with the reductions in weight and costs currently desirable in the automotive sector.

### SUMMARY

Therefore, an object of the invention is to improve a vehicle seat in this regard.

This object is achieved both with a vehicle seat as described herein.

In this instance, according to a first aspect of the invention, there is proposed a vehicle seat which uses a self-locking-free drive device both for adjusting the backrest in the position for use in order to take up different comfort positions and for adjusting the backrest from the position for use into the non-use position and/or vice versa out of the non-use position into the position for use, wherein an external-force-actuated adjustment of the backrest can be carried out by means of the drive device for the respective cases. In other words, there is provided a self-locking-free drive device which has at least one drive motor, preferably an electric motor, on the vehicle seat, and by means of which not only can different comfort positions be adjusted with actuation by an external force but it is also possible to fold the backrest forward and/or backward with actuation by an external force.

Consequently, by different adjustment movements being able to be carried out with actuation by an external force by means of the drive device according to the invention, different drive devices for the different adjustment movements are unnecessary. As a result of the self-locking-free configuration of the drive device, it is further ensured that the respective adjustment movement can be carried out manually where applicable, that is to say, in particular in the event of a failure of a drive motor of the drive device. Consequently, the drive device itself does not block an adjustment of the backrest if it is not actuated. Instead, it is preferable to combine the self-locking-free drive device with a fitting arrangement which secures the backrest in the adjustment position taken up in each case relative to the lower seat member and which can be unlocked not only via the drive device with actuation by an external force and can be driven for an adjustment of the backrest, but instead which can also additionally be unlocked manually and/or actuated for adjustment of the backrest.

For example, the self-locking-free drive device is combined with a fitting arrangement which has at least one catch fitting. In the case of combination with a catch fitting, there may be provision for unlocking of the catch fitting to be carried out with actuation by an external force via the self-locking-free drive device so that the backrest can be freely pivoted via the unlocked catch fitting. That free pivoting for adjusting the inclination and the folding of the backrest backward and/or forward can then be carried out manually or with actuation by an external force via a drive motor of the drive device. For the manual adjustment of the backrest, the catch fitting is preferably configured in such a manner that it can also be unlocked manually. In a variant, there may also be provided a combination between manual unlocking and adjustment actuated with an external force so that the self-locking-free drive device is provided for the external-force-actuated adjustment of the backrest while the catch fitting can be manually unlocked in order to allow an adjustment in the position for use, folding of the backrest forward and/or folding of the backrest backward.

The drive device preferably has a self-locking-free mechanism. As a result of a self-locking-free mechanism, an overload protection is provided. Furthermore, there is thereby produced a better degree of efficiency with respect to self-locking mechanisms, whereby the drive power can be reduced for a comparable adjusting characteristic, such as in a rotational fitting.

As already mentioned above, in a preferred construction variant there is provision for a fitting arrangement of the vehicle seat to be connected electronically and/or mechanically to the self-locking-free drive device. That connection is carried out in this instance in such a manner that a locking of the backrest relative to the lower seat member is carried out via a component of the fitting arrangement automatically or independently in a position for use and/or non-use position which is taken up with actuation by an external force. Alternatively or additionally, the drive device and the fitting arrangement can be connected in order to carry out a pivot movement of the backrest relative to the lower seat member via a component of the fitting arrangement, which pivot movement is actuated by an external force and controlled by means of the drive device. Thus, for example, a locking or securing of the backrest can be carried out by means of a catch fitting of the fitting arrangement and alternatively or additionally an adjustment force which is produced by the drive device can be introduced into a fitting component in order to pivot the backrest relative to the lower seat member with actuation by an external force. By means of the fitting arrangement, both an inclination adjustment of the backrest and a pivoting of the backrest into the non-use position and/or into the position for use may be possible without activation of the drive device. Since the drive device is self-locking-free, the fitting arrangement can further be configured to allow a manual adjustment of the backrest without activating a drive motor of the drive device.

For example, the fitting arrangement may form a catch fitting which can be unlocked with actuation by an external force—preferably via the same drive device—in order subsequently to adjust the backrest by means of the drive device with actuation by an external force.

In an embodiment, there is provided an electronic control unit of the drive device which implements control logic for controlling the locking. In this instance, a drive element of the drive device for the external-force-actuated adjustment of the backrest is driven in a drive direction by means of the electronic control unit. After a desired relative position of the backrest is reached with respect to the lower seat member and after the backrest has been locked in the relative position taken up, the drive element is then driven in a direction counter to the drive direction and it is evaluated on the basis of a measurement signal detected whether the locking is provided in accordance with provisions. If a locking of the backrest in accordance with provisions in the relative position taken up has been brought about, the drive element can no longer be adjusted in the opposite direction beyond an admissible extent. In a variant, for example, an electric motor of the drive device is supplied with electric current after the backrest has been locked and after associated engagement of the fitting in an opposite direction. On the basis of a measurement signal which represents the motor current, it is then possible to verify whether the locking is provided correctly. If the locking operation has been carried out, the measurable motor current increases powerfully in a characteristic manner since the drive element moves en bloc.

In principle, the electronic control unit may be constructed in this instance to carry out the verification mentioned both in the case of adjustment of the backrest in the position for use and in the case of a change between the non-use position and position for use.

In a construction variant, the self-locking-free drive device has at least one linear drive having a translationally adjustable drive element, such as, for example, a spindle, a spindle nut, a lifting piston or a push rod. Thus, for example, the linear drive may be constructed as a spindle drive or be pneumatic or hydraulic.

In an embodiment, the linear drive is (completely) arranged at the backrest and received thereon. In this instance, the linear drive may be retained via at least one rotational bearing on the backrest. For this purpose, for example, a housing of a drive motor of the linear drive is fixed to the backrest for pivoting about a rotation axis. The linear drive can be adjusted about a rotation axis which is defined on the backrest via the rotatable bearing of the motor housing thereof in the case of pivoting of the backrest about the backrest pivot axis thereof. In this manner, an easy pivot movement can be carried out by the linear drive when the backrest is pivoted and results from the translational adjustment of the drive element and the connection thereof with a lever mechanism which is provided to convert a translational movement of the drive element into a pivot movement of the backrest.

In particular in such an embodiment, the drive element of the linear drive is preferably adjustable substantially in a longitudinal direction of the backrest. That longitudinal direction of the backrest extends in a position for use of the backrest along the spinal column of a seat occupant who is sitting on the vehicle seat in accordance with provisions. In this instance, the drive element is longitudinally adjusted within the backrest in order to produce an adjustment force for pivoting the backrest about the pivot axis of the backrest thereof.

In order to convert the translational adjustment movement of the drive element of the linear drive into a pivot movement of the backrest, for example, there is provided a connection member, preferably as a portion of a lever mechanism. That connection member is, on the one hand, articulated to the drive element and, on the other hand, articulated to a support element which is fixed to the lower seat member, and rigid. In a construction variant, the connection member is formed by two pivot levers which are arranged parallel with each other.

In a possible development, a sliding element is further provided. That sliding element is connected to the connection member in the region of an articulated connection between the translationally adjustable drive element and the connection member and in a sliding manner abuts a guide which is fixed to the backrest. That guide may be formed, for example, by a slotted guiding member which provides a specific adjustment path for the sliding element which is connected to the connection member when the drive element is adjusted via the linear drive with actuation by an external force.

A linear drive which is provided on the backrest preferably forms a portion of a structure of the backrest reinforcing the backrest frame. By the linear drive itself therefore being selectively used to reinforce the backrest, the linear drive integrates an additional function and structural components of the backrest frame may have smaller dimensions or even be completely dispensed with. Naturally, however, the use of a linear drive as a portion of a structure which reinforces the backrest frame can hereby also be combined in this instance in a manner independent of the use of a self-locking-free drive device, as provided for in accordance with the first aspect of the invention.

The linear drive preferably extends, in the case of use as a portion of a reinforcing structure of the backrest frame, in a longitudinal direction of the backrest, for example, along a lateral edge region. In this manner, for example, a longitudinal strut or lateral strut of the backrest frame may have smaller dimensions as a result of the linear drive.

Alternatively or additionally, the linear drive may be partially arranged in a cavity which is defined by a frame portion of the backrest frame, such as, for example, the lateral strut of the backrest mentioned.

In order to improve the reinforcement function as a result of the elongate linear drive, it preferably extends over a large portion, that is to say, at least 60% or at least 80% of the length of the backrest in relation to the longitudinal direction of the backrest.

In the course of cross-platform use of different components, there may be provision for the linear drive to be constructed as a separate structural unit which is also configured for assembly on a rear door of a vehicle in order to adjust the rear door via the linear drive with actuation by an external force. Consequently, the linear drive is configured optionally to be used to adjust a rear vehicle door or to adjust a backrest of a vehicle seat.

In a construction variant, the drive device comprises a self-locking-free planetary gear. It is preferably constructed in several stages, that is to say, at least two stages. In this instance, consequently, at least two sequentially connected planetary gear stages are then provided. Each of those stages has a step-up ratio greater than 1 and is therefore constructed as a step-down gear stage in order to use a comparatively fast-rotating electromotive drive not only to be able to fold the backrest forward into a non-use position and/or out of it back into a position for use, but also to be able to finely adjust the backrest in the position for use in terms of the inclination thereof in relation to the lower seat member.

The planetary gear preferably has a total of one step-up ratio greater than 2, in particular greater than 3. In one embodiment, each of the sequentially connected planetary gear stages already has a step-up ratio greater than 2, in particular greater than 3. For example, the step-up ratio of each planetary gear stage is in the range from 4 to 5.

In a construction variant, there is further provided at least one spur gear stage in addition to the self-locking-free planetary gear which is where applicable constructed to have multiple stages. For example, such a variant is implemented by two mutually connected gear units, of which a first gear unit has a multi-stage planetary gear and a second gear unit has a spur gear stage. The second gear unit is then preferably connected to a drive pinion, via which the backrest is driven to produce a pivot movement. The toothed wheels of the planetary gear and/or the spur gear stage preferably have an oblique involute toothing.

For an arrangement which is as compact and efficient in terms of structural space as possible for the drive device, it is also preferable in this construction variant for at least one drive motor of the drive device and the planetary gear to be arranged on the backrest.

For example, a drive pinion which meshes with a toothed wheel portion fixed to the lower seat member on a fitting arrangement can be driven by the drive motor and the planetary gear and where applicable via an additional spur gear stage. In this instance, the toothed wheel portion is constructed by a toothed wheel or toothed wheel segment on a catch fitting and in this case preferably on a component (which is provided in any case) of the fitting. In this variant, the fitting is then consequently used not only for locking the backrest in a relative position taken up as a portion of the catch fitting, but also as a counter-element for rolling the drive pinion in order to pivot the backrest.

According to another aspect of the invention, which can readily be combined with the above-mentioned aspects of the invention, there is proposed a vehicle seat which has on the lower seat member thereof at least one seat wall adjuster, via which a seat wall which is provided on the seat face can be adjusted and which is connected to a drive device for adjusting the backrest in order to transmit an adjusting force to the seat face adjuster when the backrest is pivoted into a non-use position.

The adjustment of the seat wall is preferably carried out in this instance so that the seat wall in the non-use position projects laterally at the seat face not at all or only to a minimum extent, that is to say, for example, is folded in or retracted if the backrest is pivoted forward onto the lower seat member. The seat cushion provided on the lower seat member thereby takes up as little room as possible in the direction toward the forward-pivoted backrest. This is particularly advantageous when the backrest is pivoted forward into a so-called cargo position. Thus, it is possible as a result of the inward folding or retraction of the seat wall(s) provided in accordance with the invention for the vehicle seat always to be planar to the maximum extent in the cargo position. When the backrest is pivoted forward out of a position for use into a cargo position, consequently, for example, the drive device automatically pulls the seat walls back via the seat wall adjuster, whereby a smaller packing dimension of the vehicle seat is produced and the vehicle seat can be folded to be flatter. A seat wall adjuster is in this instance constructed, for example, in accordance with WO 2006/024268 A1 and connected to the drive device mechanically via a Bowden cable mechanism.

In principle, there may be provision for the drive device which is provided with a drive motor to be connected to at least one sensor of the vehicle seat and for an electronic control unit of the drive device to control the drive motor of the type on the basis of signals of the at least one sensor in such a manner that oscillations of the vehicle seat which occur are compensated for by means of the adjustment of the backrest during travel and/or the drive device is selectively tensioned in the event of oscillations counter to possible play within the drive train.

A drive device according to the invention, in particular in accordance with the first aspect of the invention, may also be combined with a belt or lock feeder.

Alternatively or additionally, a pre-crash adjustment can be produced via a motorized drive of the drive device. In this instance, sensors in the vehicle identify an imminent collision and the drive device moves the vehicle seat in reaction thereto so that a fitting arrangement of the vehicle seat is already preloaded and any play present within the fitting arrangement is removed. In this instance, it would also be conceivable for the fitting arrangement to be adjusted in order to ensure minimal distortion within the system.

In principle, there may be provision for occupation of a seat to be detected by sensors in order to adjust the backrest at different speeds with actuation by an external force in a manner adapted thereto. If, for example, the seat is not occupied by a seat occupant, an adjustment can be carried out within the comfort range, that is to say, in a position for use, and/or the pivoting into a cargo position, more rapidly than an inclination adjustment of the backrest in the comfort range when occupation of the seat is detected.

In an embodiment, a subsequent backrest activity may also be able to be driven via a drive motor of the drive device. Thus, for example, an active unclipping of a gap cover which is provided between the backrest and the storage space cover can thereby be carried out with actuation by an external force. Such unclipping actuated by an external force is considered to be advantageous, for example, when the backrest is folded forward into a cargo position and increases the operating comfort because an additional operation for unclipping the gap cover is saved in this instance for a user.

### BRIEF DESCRIPTION OF THE DRAWINGS

Additional advantages and features of the invention will become clear in the following explanation of embodiments with reference to the Figures.

FIGS. 1A-1C are perspective views of an embodiment of a vehicle seat according to the invention for the second or third seat row of a motor vehicle with a backrest in an upright position for use and with different degrees of detailing in the case of a drive device integrated in the backrest.

FIG. 2 is a side view of the vehicle seat of FIGS. 1A to 1C.

FIGS. 3A-3F are different views of details of the backrest drawn to an enlarged scale.

FIG. 4 is a side view of the vehicle seat with its backrest during adjustment in the direction of a cargo position onto a lower seat member of the vehicle seat.

FIGS. 5A to 5B are perspective views of details of the drive device drawn to an enlarged scale.

FIG. 6A is a side view of the vehicle seat with the backrest in the cargo position thereof.

FIG. 6B is a perspective view drawn to an enlarged scale of the vehicle seat with the backrest in the cargo position thereof;

FIG. 7 is an exploded illustration of the drive device for adjusting the backrest

FIG. 8 is a perspective view of another embodiment of a vehicle seat according to the invention for the second or third seat row of a motor vehicle with an alternatively configured drive device for adjusting the backrest.

FIGS. 9A to 9B show details of the drive device of the vehicle seat of FIGS. 7 and 8 drawn to an enlarged scale.

FIGS. 10 A to 10C show details of the drive device drawn to a further enlarged scale with respect to FIGS. 9A and 9B.

### DETAILED DESCRIPTION

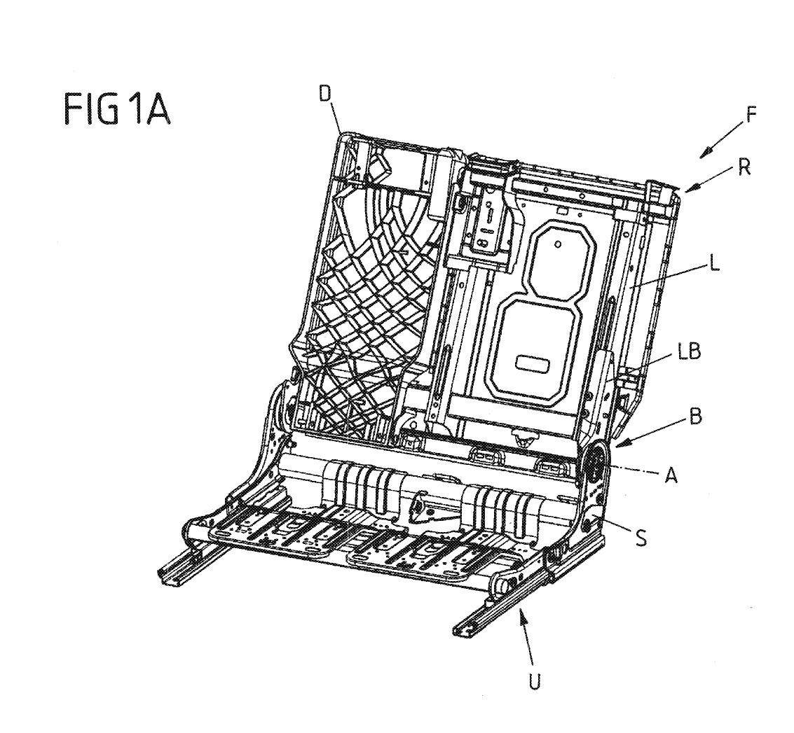

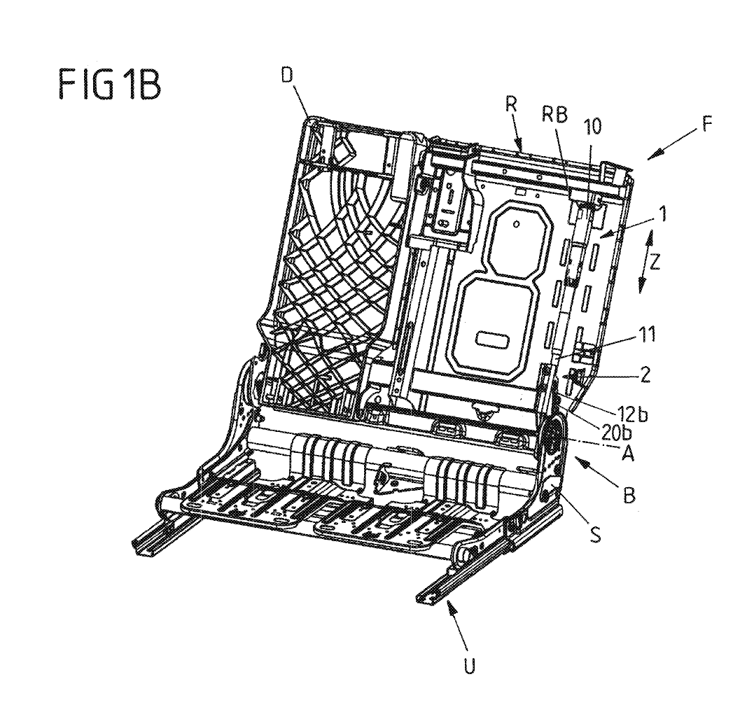

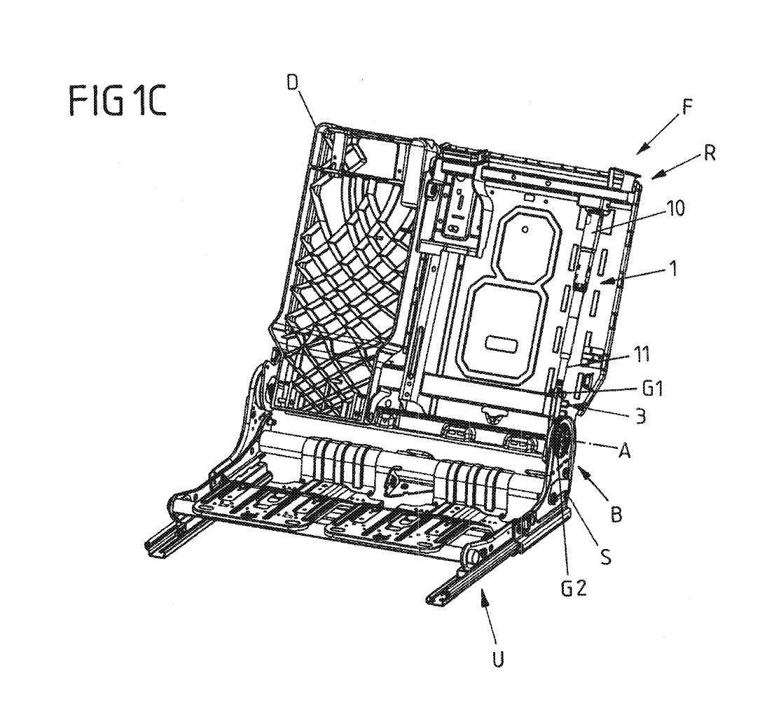

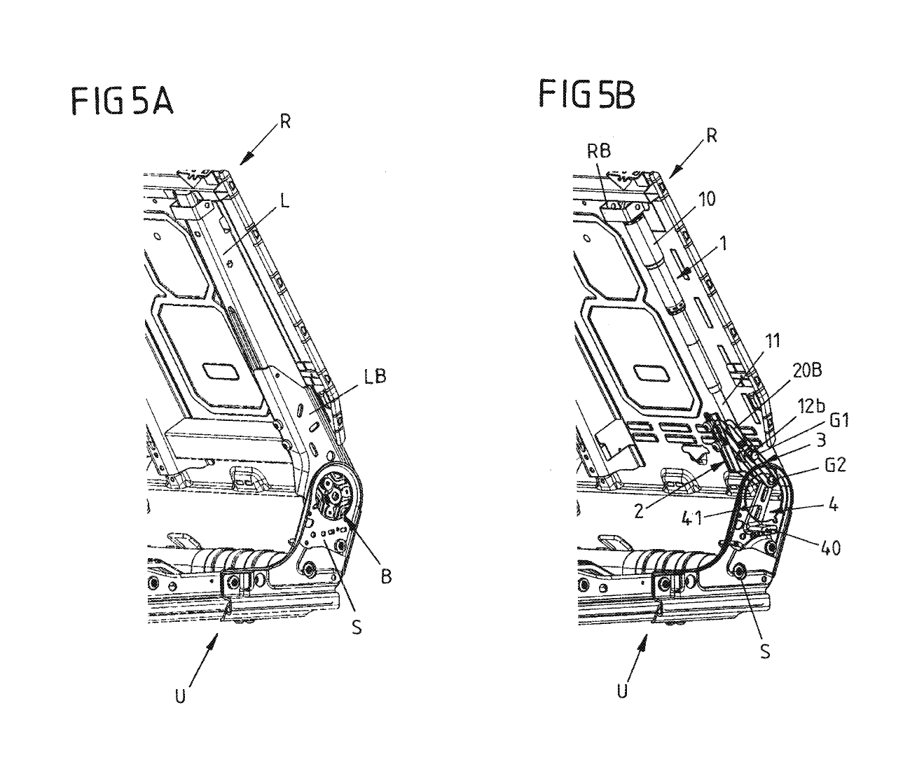

FIGS. 1A to 7 show a first embodiment of a vehicle seat F according to the invention in which a backrest R can be pivoted about a pivot axis A of the backrest relative to a lower seat frame U which defines a lower seat member. In this instance, the vehicle seat F is provided for the second or third seat row of a motor vehicle and is constructed as a so-called ⅔ seat with a through-loading portion D.

The backrest R is pivotably supported on a lateral seat member S of the lower sea frame U via a fitting arrangement with fittings B which are arranged at both transverse sides. A fitting B may, for example, be a catch fitting which can be actuated in this case not only manually but also with actuation by an external force by means of a preferably electromotive drive. In this instance, a drive device which is integrated in the backrest R is provided so as to have a self-locking-free linear drive 1 in order to adjust the backrest R with actuation by an external force in terms of the inclination thereof about the backrest pivot axis A thereof on the one hand in a position for use with respect to the lower seat frame U and, on the other hand, to pivot it out of the position for use illustrated in FIGS. 1A to 1C into a cargo position onto the lower seat frame U, and to pivot it back again into the position for use. The drive device having the linear drive 1 consequently allows adjustment actuated by an external force of the backrest R. on the one hand, in the position for use in order to be able to adjust different comfort positions of a so-called comfort (adjustment) range and an adjustment from the position for use into a non-use position, and vice versa.

An adjustment force which acts on a fitting B is transmitted to the opposite fitting via a transmission or transverse shaft Q in the lower region of the backrest R in order, for example, to release a lock in the case of a catch fitting. As a result of the self-locking-free configuration of the linear drive 1, it is further possible in this instance not only to manually actuate the fitting B but also to manually adjust the backrest R.

The self-locking-free linear drive 1 is in this instance received completely on the backrest R in the region of a backrest frame member which is formed by a lateral backrest strut L. The lateral backrest strut L extends in a backrest longitudinal direction Z and forms a cavity, inside which the linear drive 1 with the drive motor 10 and a push rod 11 extends as the drive element. The linear drive 1 extends in this instance practically over the complete length of the backrest R and therefore acts in the region of the lateral backrest strut L in a reinforcing manner. In this instance, the linear drive 1 forms a portion of a reinforcement structure of the backrest frame of the backrest R so that the lateral backrest strut L can have smaller dimensions in this region than in a backrest without the linear drive 1.

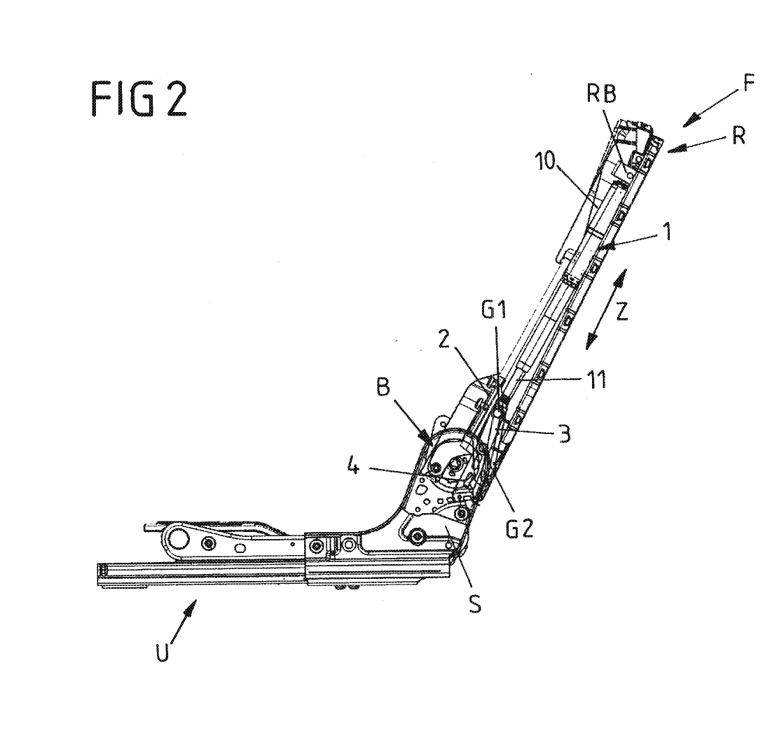

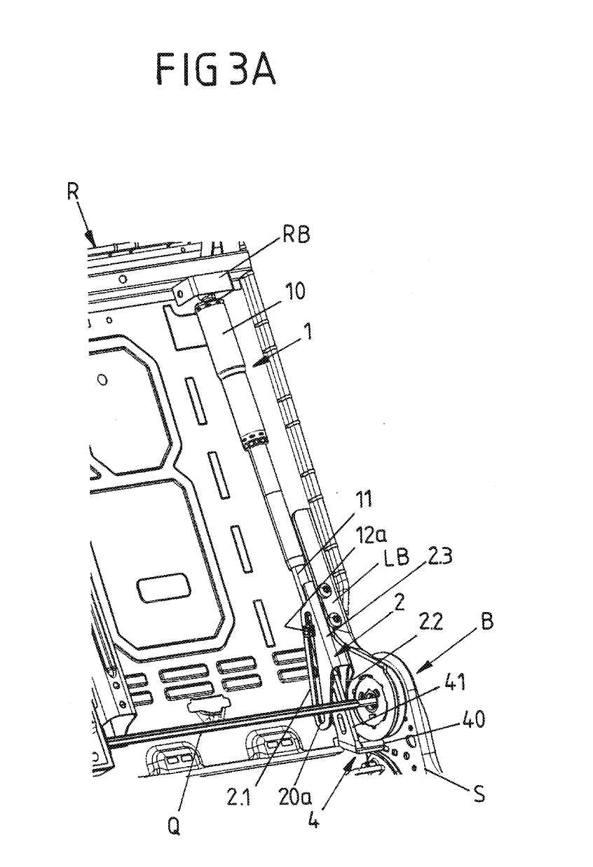

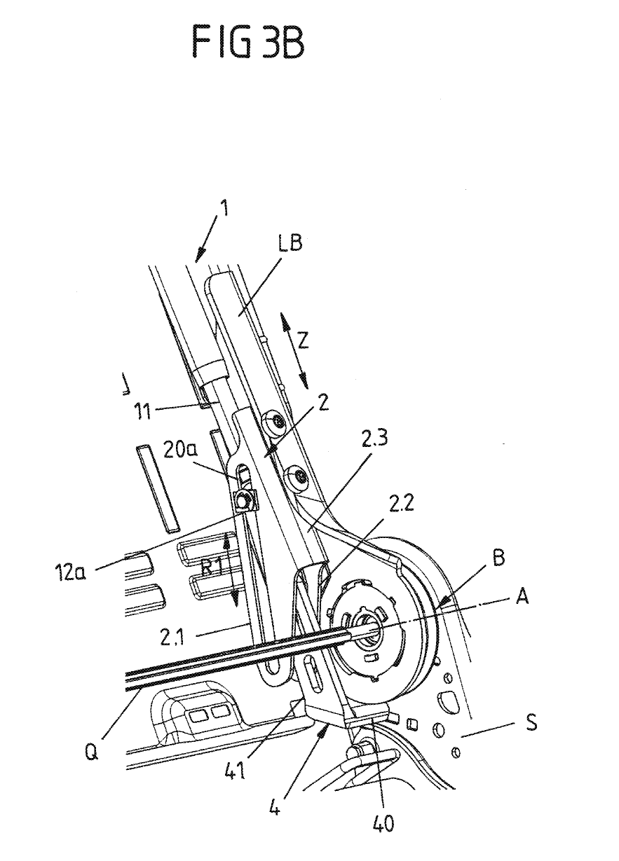

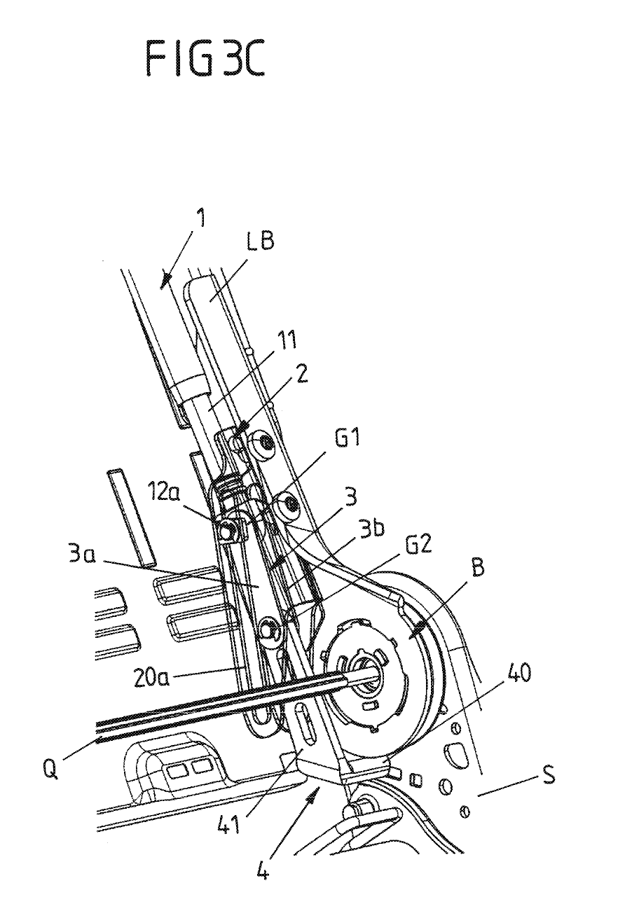

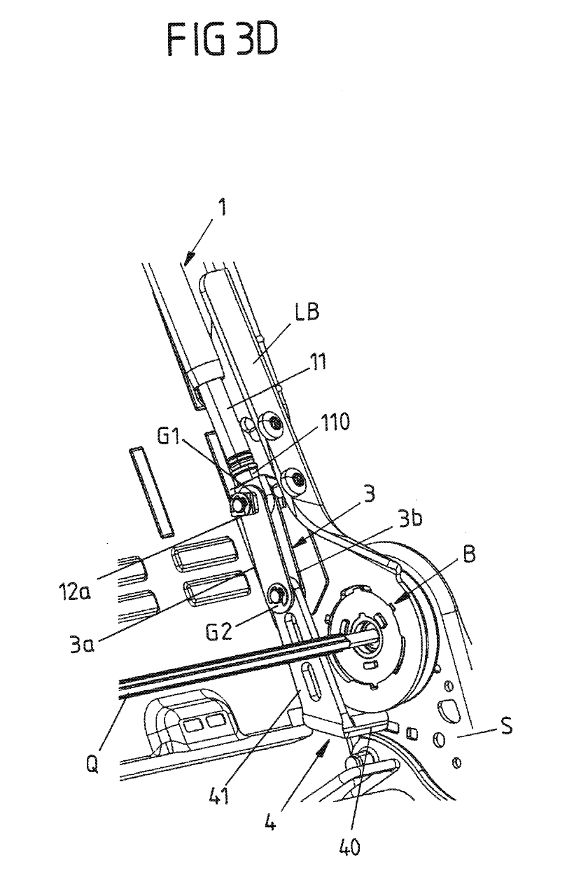

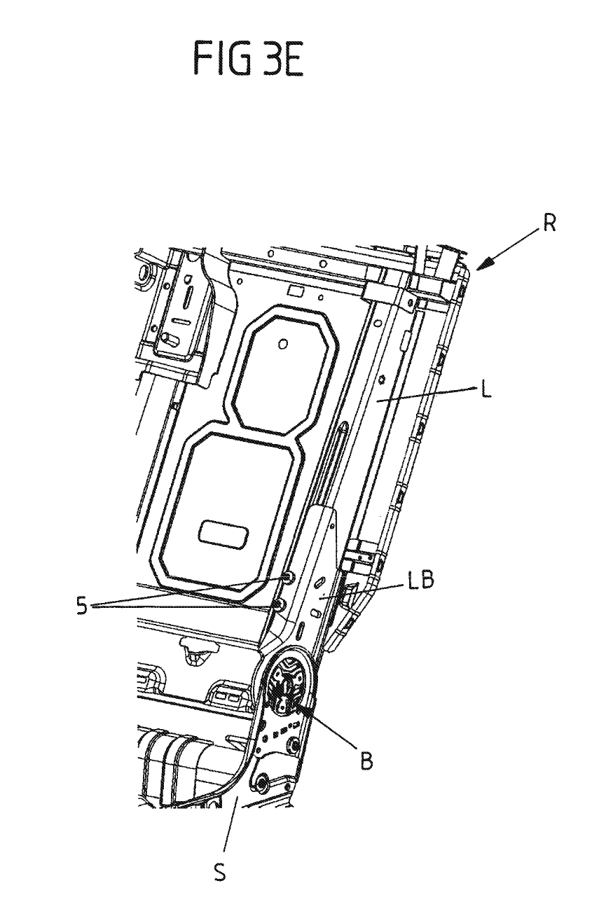

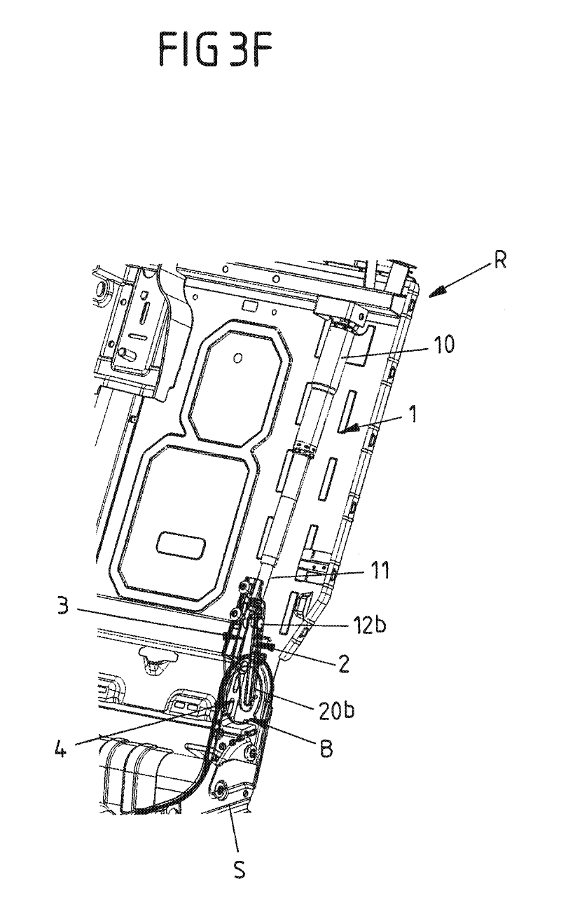

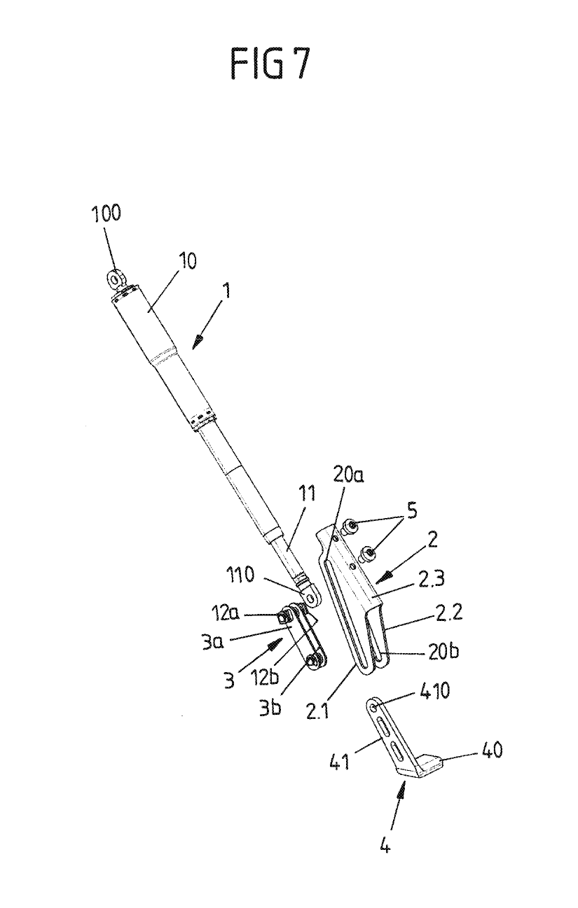

As particularly illustrated in greater detail when FIGS. 1A to 1C are viewed together with FIGS. 2 and 3A to 3F, the drive motor 10 of the linear drive 1 drives the push rod 11 to produce a longitudinal movement substantially in the backrest longitudinal direction Z in order to pivot the backrest R about the backrest longitudinal axis A thereof. In the region of an upper end, the housing of the drive motor 10 is suspended in a rotatable manner via a bearing eye 100 on a fixing region RB of the backrest R and connected to the backrest frame of the backrest R. At the opposite lower end, the push rod 11 can be extended and retracted by the drive motor 10. In order thereby to pivot the backrest R about the backrest longitudinal axis A, the push rod 11 is connected to a lever mechanism of the drive device. For this purpose, the push rod 11 has at the projecting and thereof a connection piece 110 which is connected in an articulated manner to a connection member 3 which is formed by two pivot levers 3a and 3b (cf. also FIG. 7).

The two pivot levers 3a and 3b of the connection member 3 are articulated at one lever end to the connection piece 110 of the push rod 11 and articulated at the other lever end to a support element fixed to the lower seat frame in the form of an angled support member 4. Furthermore, there is provided a guide component 2 which is fixed to the backrest and which is fixed via fixing elements 5—in this case, in the form of screws—via a connection portion 2.3 to the backrest frame of the backrest R. The guide component 2 has two guide walls 2.1 and 2.2 which extend parallel with each other and which are connected to each other via the connection portion 2.3. Each guide wall 2.1 and 2.2 forms a slotted guiding member 20a or 20b. A guide pin having a sliding element which is provided thereon and which is in the form of a sliding piece 12a or 12b is guided in a sliding manner therein.

Those sliding pieces 12a and 12b are securely connected to one or other pivot lever 3a, 3b at both sides of the connection piece 110. In this manner, each sliding piece 12a, 12b is displaced along the associated slotted guiding member 20a or 20b thereof if the push rod 11 is retracted or extended. The slotted guiding members 20a and 20b extend in this instance in a slightly inclined manlier relative to the backrest longitudinal axis Z. A sliding direction R1, along which the sliding pieces 12a and 12b are displaced, and therefore a first articulated connection G1 between the push rod 11 and connection member 3, consequently extends in a state inclined at an angle relative to the backrest longitudinal axis Z and the adjustment axis of the push rod 11. By a first articulated connection G1 being formed between the push rod 11 and the connection member 3 and a second articulated connection G2 being formed between the connection member 3 and the angled support member 4 fixed to the lower seat frame and the guide component 2 being fixed to the backrest frame in a non-movable manner, a translational movement of the push rod 11 results in a pivot movement of the backrest R about the backrest pivot axis A. As a result of the rotational bearing of the linear drive 1 in the fixing region RB on the backrest R. it can readily be tilted about the backrest pivot axis A in the case of a pivot movement of the backrest R in order to carry out the pivot movement.

While a backrest plate LB is provided as a retention element for fixing the guiding component 2 to the backrest R and the backrest frame thereof, the angled support member 4 is directly fixed to the lateral seat member S. To this end, a fixing portion 40 of the angled support member 4 engages through the lateral seat member S under the fitting B. For example, the fixing portion 40 can be welded to the lateral seat member S.

A bearing arm 41 of the angled support member 4 extends substantially perpendicularly to the fixing portion 40. At the outer end of that bearing arm 41 there is located a bearing eye 410 for the articulated connection with the connection member 3 and the two pivot levers 3a and 3b thereof (for example, via a bearing pin which is fitted through the bearing eye 410 and which is rotatably supported therein and which is securely connected at one end to a pivot lever 3a or 3b).

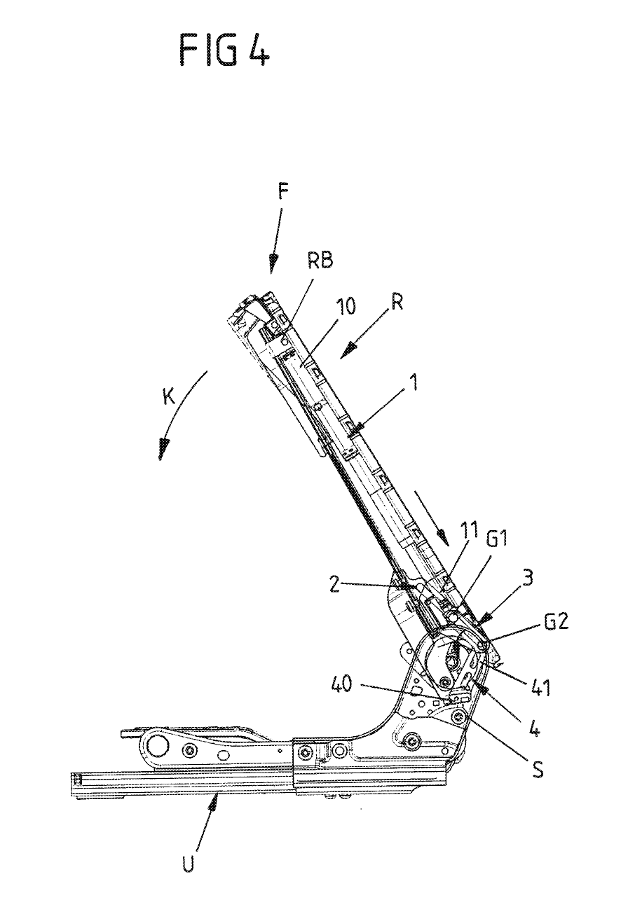

With reference to FIGS. 4, 5A-5B and 6A-6B, the external-force-actuated adjustment of the backrest R is illustrated in greater detail. In this instance, the mentioned Figures show in detail the forward pivoting of the backrest R onto the lower seat frame U into a so-called cargo position, in which the backrest R is used to provide an increased storage space.

When the backrest R is folded forward about the backrest pivot axis A in a folding direction K in the direction toward the lower seat frame U. the push rod 11 is substantially extended along the backrest longitudinal axis Z via the drive motor 10. Consequently, the push rod 11 presses on the connection member 3 which is articulated to the angled support member 4 fixed to the lower seat frame via the articulated connection G2, and is force-guided in the region of the other articulated connection G1 with the push rod end on the guiding component 2 fixed to the backrest. As a result, the connection member 3 is pivoted about the rotation axis which extends parallel with the backrest pivot axis A and which is defined by the articulated connection G2 as a result of the extension of the push rod 11, and the backrest R is pivoted forward. Consequently, an adjusting force is produced by means of the linear drive 1 and urges the backrest R out of a position for use into the non-use position of the cargo position.

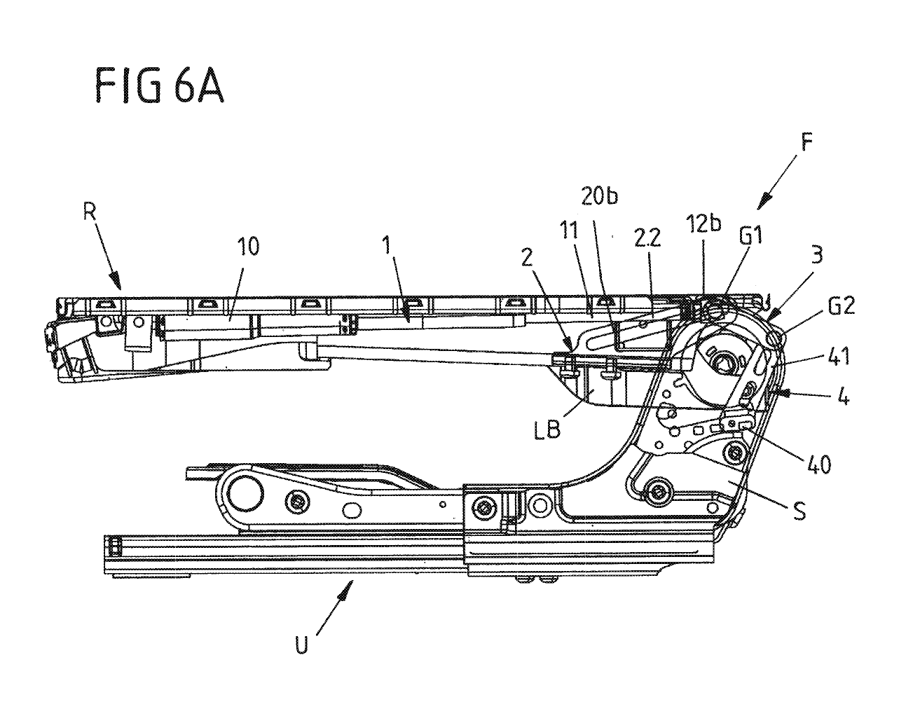

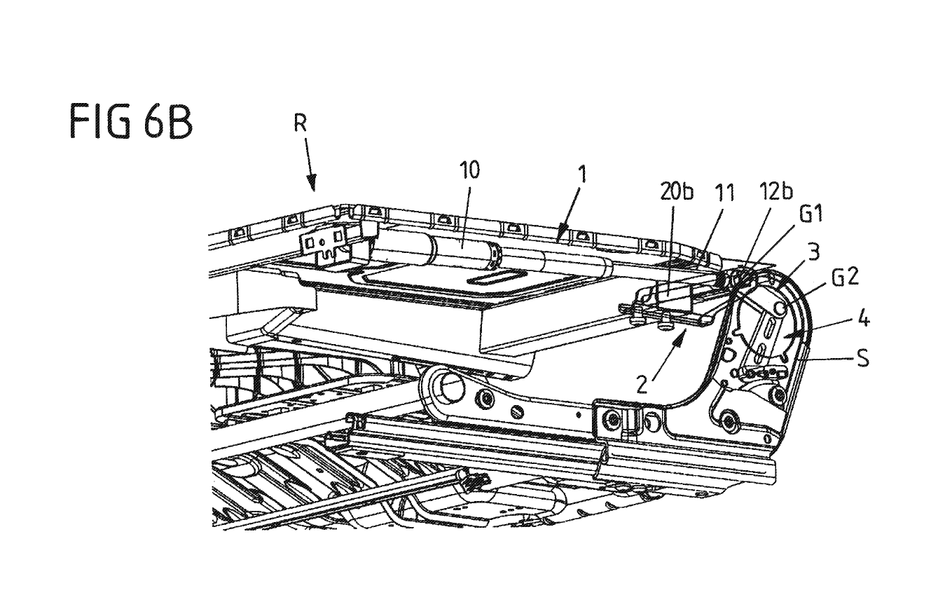

If the backrest R has reached its cargo position in accordance with FIGS. 6A and 6B, the sliding pieces 12a and 12b are located inside the associated slotted guiding member 20a and 20b thereof at a lower end and the push rod 11 is extended to its maximum extent. In the cargo position, the backrest R is secured relative to the lower seat frame U via the fitting B. If the fitting B is a catch fitting, for example, there is provided a separate actuator which retains the catch fitting in an unlocking position during the forward folding of the backrest R. and again allows a locking via the catch fitting B after the cargo position has been reached. If the backrest R is intended to be folded back out of the cargo position thereof again, the fitting B is again actuated before the push rod 11 of the linear drive 1 is retracted.

As a result of the self-locking-free linear drive 1 being used, the backrest R can in this instance also be manually folded back into the position for use thereof. Similarly, an adjustment of a comfort position in the position for use can be carried out manually. To this end, it is simply necessary to actuate the fitting B via an actuator element which is not illustrated in greater detail here, for example, an actuation lever. In order to increase the comfort, there may further be provision for the linear drive 1 to have an electronic control unit, by means of which pivoting of the backrest R about the backrest pivot axis A thereof is carried out within the adjustment range defining the position for use at a first adjustment speed, while a forward-folding of the backrest R into the cargo position thereof and the backward-folding of the backrest R out of the cargo position is carried out via the linear drive 1 at a second greater adjustment speed. It is possible to provide a control of the drive motor 10 via a pulse-width modulation for implementing different speeds in the comfort range and during folding into the cargo position or during folding back out of the cargo position.

In this instance, the linear drive 1 is further constructed as a structural unit which can be mounted separately on the backrest R and which can be connected to the lever mechanism having the connection member 3 and which is also configured for the external-force-actuated adjustment of a rear door, in particular a storage space cover of a motor vehicle. The same structural unit can consequently optionally be used for adjusting a backrest R on a vehicle seat or adjusting a rear door.

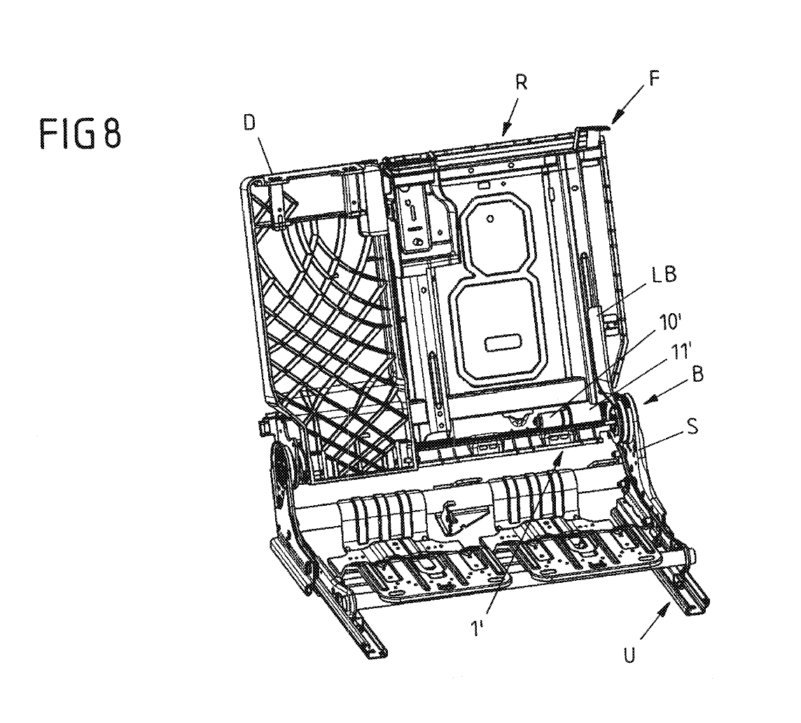

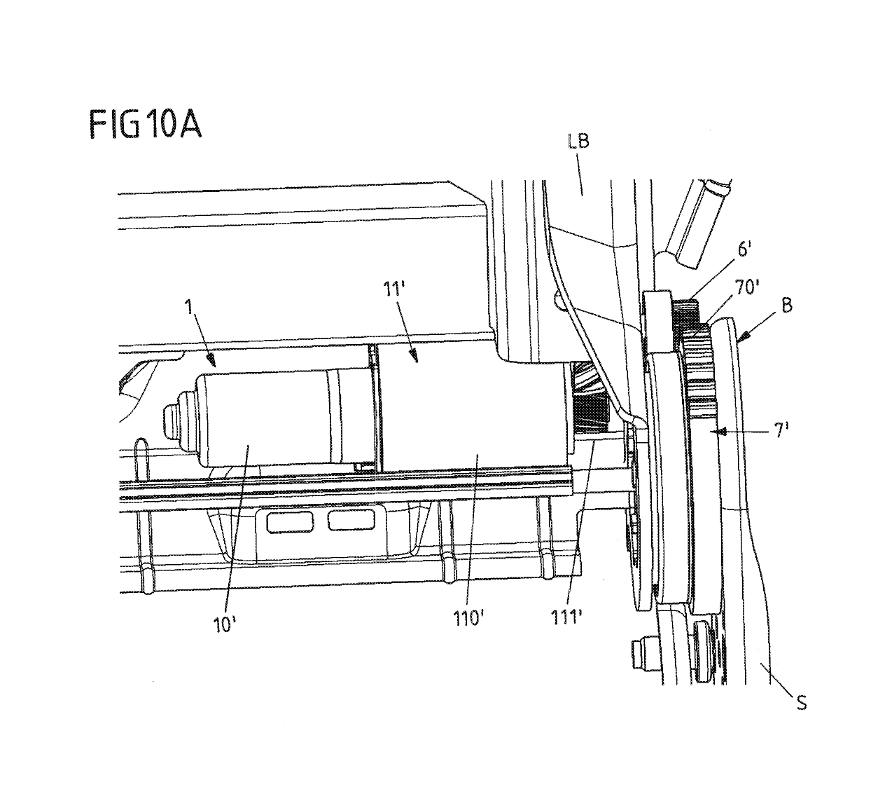

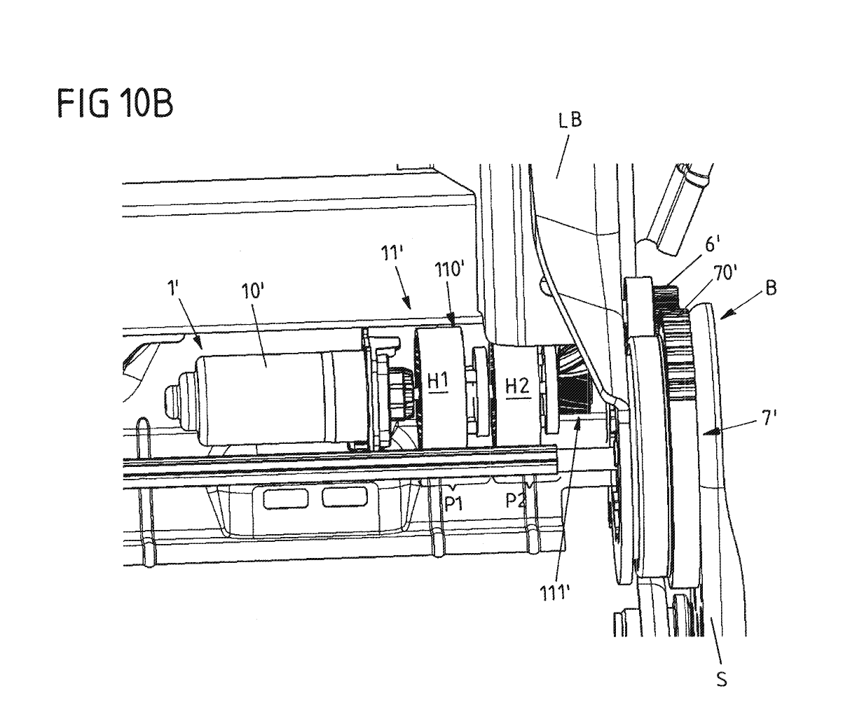

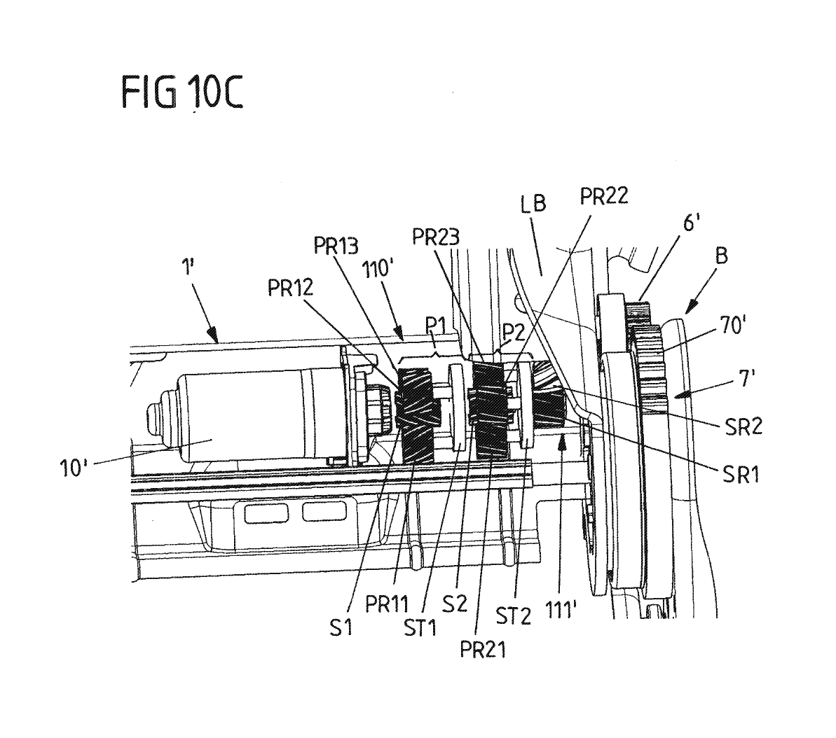

FIGS. 8, 9A-9B and 10A-10C illustrate another construction variant of a vehicle seat F according to the invention. In this construction variant, a drive 1′ having a self-locking-free planetary gear is provided in place of the linear drive 1 for external-force-actuated adjustment of the backrest R.

The drive 1′ has inter alia a drive motor 10′ which is constructed as an electric motor and a gear device 11′ which are both completely received on the backrest R. in this instance in the region of the transverse shaft Q which connects the two fitting sides.

The gear device 11′ comprises two gear units 110′ and 111′ which transmit a torque which is produced by the drive motor 10′ to a drive pinion 6′ which is rotatably supported on the backrest R. in this instance on the backrest plate LB in the region of the fitting B. The drive pinion 6′ meshes with a fitting-side toothed wheel 7′ which is fixed to the lateral seat member S of the lower seat frame U. The toothed wheel 7′ which is fixed to the lower seat frame has an outer toothing 70′ with which the drive pinion 6′ is engaged. The outer toothing 70′ extends in this case over approximately 120° on an outer periphery of the toothed wheel 7′. In this manner, not only the adjustable comfort positions of the backrest R can be covered in a position for use, but also the forward-folding of the backrest R into the cargo position thereof and the backward-folding of the backrest R into a position for use as a result of the meshing of the drive pinion 6′ with the outer toothing 70′ of the toothed wheel 7′. Alternatively to the toothed wheel 7′, for example, the use of a toothed ring or a toothed wheel segment having an outer toothing 70′ would also be possible. In order to reduce components and optimize costs, the toothed wheel 7′ can further be constructed by a fitting component which is fixed to the lower seat frame and which is provided in any case.

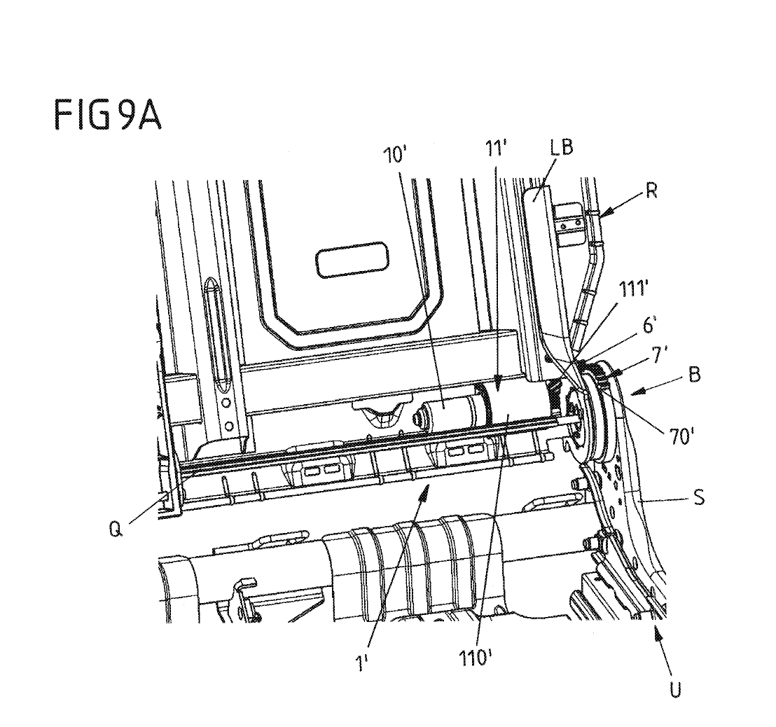

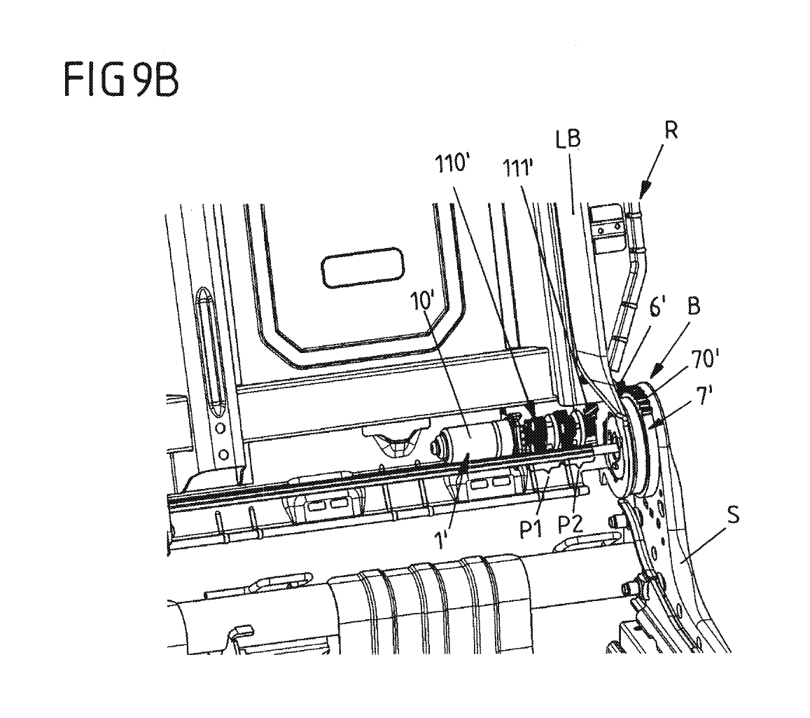

In this instance, an adequate step-down ratio for driving the drive pinion 6′ is provided via the gear device 11′ with the two gear units 110′ and 111′ thereof. The first gear unit 110′ is in this instance constructed as a two-stage planetary gear unit while a spur gear unit is provided as the second gear unit 111′. As can be seen in particular in the detailed illustrations of FIGS. 9B, 10B and 100, the planetary gear unit 110′ is in this instance connected upstream of the spur gear unit 111′ and has two gear stages P1 and P2.

In the first gear stage P1, a drive shaft of the drive motor 10′ drives a sun gear S1. When the internally toothed wheel H1 of the first gear stage P1 is fixed in position, a web ST1 of the first planetary gear stage acts with the planetary wheels PR11. PR12 and PR13 which are rotatably supported thereon and which are driven by the sun wheel Si as a power take-off. A sun wheel S2 for the gear stage P2 is arranged on the web ST of the first gear stage P1 in a rotationally secure manner. In the subsequent second gear stage P2, the power take-off also occurs with the internally toothed wheel H2 in a fixed position via a web ST2, on which planetary wheels PR21. PR22 and PR23 are rotatably supported. Both gear stages P1 and P2 are preferably configured in this instance in such a manner that a step-down ratio is thereby achieved for a speed ratio of greater than 2, preferably greater than 3, in each stage.

A spur gear SR1 is arranged on the web ST2 of the second gear stage P2 coaxially relative to the drive shaft of the drive motor 10′ and the sun wheels S1 and S2 of the two planetary gears of the gear stages P1 and P2. That spur wheel SR1 is part of the spur gear unit 111′ and meshes with a second spur gear SR2 which is rotatably supported in the region of the backrest plate LB or directly on the backrest plate LB. The drive torque is transmitted to the drive pinion 6′ via the spur gear unit 111′ with the spur gears SR1 and SR2 and where applicable additional spur gears in order to pivot the backrest R about the backrest pivot axis A thereof.

The individual toothed wheels of the two gear units 110′ and 111′ each have an oblique involute toothing and are configured in a self-locking-free manner. A securing of the backrest R relative to the lower seat frame is consequently carried out via the fitting B (and the counterpart on the opposite backrest side). Thus, for example, there may be provided a catch fitting which is unlocked in an electronically controlled manner for the external-force-actuated pivoting of the backrest R via the drive 1′. In this instance, however, the catch fitting may further be able to be manually unlocked in order also to be able to manually pivot the backrest R when necessary or in an emergency situation. As a result of the self-locking-free drive 1′, the backrest R is not impeded during such pivoting.

In this instance, by the drive 1′ being arranged with the individual gear units 110′ and 111′ of the gear device 11′ thereof along an axis parallel with the backrest pivot axis A and the driven toothed wheels being driven about rotation axes which extend parallel with the backrest pivot axis A. the drive 1′ can be arranged on the backrest R with optimum utilization of the structural space available at the backrest R. Naturally, however, it is not at all necessary to arrange the individual gear units 110′ and 111′ in this manner in order to drive the drive pinion 6′.

As a result of the drives 1 and 1′ of the two construction variants illustrated, an external-force-actuated adjustment of the backrest R of the respective vehicle seat F is possible both in the position for use and out of the position for use into a cargo position and back, wherein it is still possible to adjust the backrest manually or without electric current (for example, for a so-called panic exit) as a result of the self-locking-free configuration of the drive 1 or 1′, respectively. A locking of the backrest R relative to the lower seat frame U is in this instance taken over via the fitting B which is provided. In this manner, a functional separation is brought about with respect to the absorption of crash forces and the absorption of conventional actuation forces. While the locked fitting B is configured for forces occurring as a result of a crash, the respective drive 1 or 1′ is subjected only to the adjustment forces which occur during normal operation, and therefore do not have to be configured for any crash event.

Although this is not illustrated in the Figures, a drive 1 or 1′ can also be operatively connected to a seat wall adjuster on the lower seat frame U—for example, via a Bowden cable mechanism. In this instance, the drive device 1 or 1′ acts on the seat wall adjuster when the backrest R is folded forward into the cargo position thereof in order to fold or to withdraw lateral seat walls on the seat face and therefore to reduce the packing dimensions of the vehicle seat F in the cargo position thereof.

### LIST OF REFERENCE NUMERALS

1 Linear drive with self-locking-free mechanism
1′ Drive with self-locking-free planetary gear
10, 10′ Drive motor
100 Bearing eye for rotational bearing
11 Push rod (drive element)
11′ Gear device
110 Connection piece
110′ Planetary gear unit (1st gear unit)
111′ Spur gear unit (2nd gear unit)
12a, 12b Guide pin/sliding piece (sliding element)
2 Guide component
2.1, 2.2 Guide wall
2.3 Connection portion
20a, 20b Slotted guiding member
3 Connection member
3a, 3b Pivot lever
4 Angled support member (support element)
40 Fixing portion
41 Bearing arm
410 Bearing eye
5 Fixing element
6′ Drive pinion (drive element)
7′ Toothed wheel
70′ Outer toothing
A Backrest pivot axis
B Fitting
D Through-loading portion
F Vehicle seat
G1, G2 Articulated connection
H1, H2 Internally toothed wheel
K Folding direction
L Lateral backrest strut (backrest frame member)
LB Backrest plate (retention element)
P1, P2 Gear stage
PR11, PR12, PR13 Planetary gear
PR21, PR22, PR23 Planetary gear
Q Transverse shaft
R Backrest
R1 Sliding direction
RB Fixing region
S Lateral seat member
S1, S2 Sun gear
SR1, SR2 Spur gear
ST1, ST2 Web
U Lower seat frame (lower seat member)
Z Adjustment direction/longitudinal backrest direction

1-21. (canceled)

22. A vehicle seat having at least
one lower seat member which defines a seat face for a seat occupant, and
a backrest which, on the one hand, can be adjusted in terms of the inclination thereof relative to the lower seat member in a position for use, in which the back of a seat occupant can be supported by means of the backrest in accordance with provisions and which, on the other hand, can be pivoted out of the position for use in the direction toward the lower seat member into a non-use position in which a person can sit on the vehicle seat not in accordance with provisions,
wherein there is provided on the vehicle seat a self-locking-free drive device, by means of which the backrest can be adjusted in terms of the inclination thereof relative to the lower seat member with actuation by an external force both in the position for use and from the position for use into the non-use position and/or vice versa can be pivoted out of the non-use position into the position for use with actuation by an external force.

23. The vehicle seat according to claim 22, wherein the drive device has a self-locking-free mechanism.

24. The vehicle seat according to claim 22, wherein the vehicle seat has a fitting arrangement for the pivotable bearing of the backrest relative to the lower seat member and the fitting arrangement is connected electronically and/or mechanically to the self-locking-free drive device so that a locking of the backrest relative to the lower seat member is carried out via a component of the fitting arrangement in a position for use and/or non-use position which is taken up with actuation by an external force and/or an external-force-actuated pivot movement of the backrest relative to the lower seat member is carried out via a component of the fitting arrangement.

25. The vehicle seat according to claim 24, wherein (a) an inclination adjustment of the backrest and/or (b) a pivoting of the backrest into the non-use position and/or into the position for use without activation of the drive device is possible by means of the fitting arrangement.

26. The vehicle seat according to claim 24, wherein the fitting arrangement forms a catch fitting which can be unlocked with actuation by an external force in order to allow an external-force-actuated adjustment of the backrest by means of the drive device.

27. The vehicle seat according to claim 26, wherein the drive device has an electronic control unit, by means of which
a drive element of the drive device is driven in a drive direction for adjusting the backrest,
the drive element is driven in a direction counter to the drive direction after the backrest has been locked relative to the lower seat member via the catch fitting and
it is assessed on the basis of a detected measurement signal whether the drive element has been adjusted in the opposite direction beyond an admissible extent in order to verify that the backrest is locked via the catch fitting in accordance with provisions.

28. The vehicle seat according to claim 22, wherein the drive device has a linear drive having a drive element which can be translationally adjusted.

29. The vehicle seat according to claim 28, wherein the linear drive is arranged on the backrest.

30. The vehicle seat according to claim 29, wherein the linear drive is retained via at least one rotational bearing on the backrest.

31. The vehicle seat according to claim 28, wherein the drive element of the linear drive can be adjusted substantially in a backrest longitudinal direction of the backrest.

32. The vehicle seat according to claim 28, wherein the translationally adjustable drive element is connected in an articulated manner to a connection member which is in turn articulated to a support element which is fixed to the lower seat member.

33. The vehicle seat according to claim 32, wherein, in the region of an articulated connection between the translationally adjustable drive element and the connection member, at least one sliding element which is connected to the connection member is connected and in a sliding manner abuts a guide which is fixed to the backrest.

34. A vehicle seat having at least
one lower seat member which defines a seat face for a seat occupant,
a backrest which has a backrest frame for supporting a backrest cushion and which can be pivoted relative to the lower seat member about a backrest pivot axis, and
a drive device, by means of which the backrest can be pivoted about the backrest pivot axis with actuation by an external force,
wherein the drive device has a linear drive which is arranged on the backrest and which forms a portion of a structure which reinforces the backrest frame.

35. The vehicle seat according to claim 34, wherein the linear drive extends in a longitudinal direction of the backrest and/or is arranged partially in a cavity which is defined by a backrest frame member of the backrest frame.

36. The vehicle seat according to claim 28, wherein the linear drive is constructed as a separate structural unit which is also configured for assembly on a rear door of a vehicle in order to adjust the rear door via the linear drive with actuation by an external force.

37. The vehicle seat according to claim 22, wherein the drive device comprises a self-locking-free planetary gear.

38. The vehicle seat according to claim 37, wherein the planetary gear is constructed so as to have multiple stages and/or there is further provided at least one spur gear stage.

39. The vehicle seat according to claim 37, wherein at least one drive motor of the drive device and the planetary gear are arranged on the backrest.

40. The vehicle seat according to claim 24, wherein the drive device comprises a self-locking-free planetary gear, wherein a drive pinion can be driven by means of the drive device and meshes with a toothed wheel portion which is fixed to the lower seat member on the fitting arrangement.

41. A vehicle seat having at least
one lower seat member which defines a seat face for a seat occupant and which has at least one seat wall adjuster, via which a seat wall provided on the seat face can be adjusted,
a backrest which has a backrest frame for supporting a backrest cushion and which can be pivoted relative to the lower seat member about a backrest pivot axis into a non-use position onto the seat face, and
a drive device, by means of which the backrest can be pivoted about the backrest pivot axis into the non-use position manually and/or with actuation by an external force,
wherein the drive device is connected to the seat wall adjuster and, when the backrest is pivoted into the non-use position, transmits an adjusting force to the seat wall adjuster in order to adjust the seat wall.
